(19) United States
(12) Patent Application Publication
(10) Pub. No.: US 2025/0304839 A1
(43) Pub. Date: Oct. 2, 2025

(54) FAST CURING AND HIGH PERFORMANCE LAMINATING ADHESIVES

(71) Applicant: DOW GLOBAL TECHNOLOGIES LLC, Midland, MI (US)

(72) Inventors: Jie Wu, Pearland, TX (US); Yinzhong Guo, Pearland, TX (US)

(21) Appl. No.: 18/863,525

(22) PCT Filed: May 15, 2023
(86) PCT No.: PCT/US2023/022221

§ 371 Date: Nov. 6, 2024

Related U.S. Application Data
(60) Provisional application No. 63/364,751, filed on May 16, 2022.

(51) Int. Cl. C09J 175/06; C08G 18/08; C08G 18/10; C08G 18/46

(52) U.S. Cl. CPC C09J 175/06; C08G 18/0852; C08G 18/10; C08G 18/4684; C08G 2170/00

(57) ABSTRACT

A solvent based retort adhesive comprising at least one isocyanate component comprising a blend of at least one aromatic based isocyanate with free monomeric isocyanate of less than 1 wt. % and at least one aliphatic-based isocyanate, and at least one NCO reactive component comprising a phosphate ester polyol and at least one polyester polyol having a molecular weight of at least 2,000 g/mol is disclosed. A process for producing the adhesive along a laminate partially comprising the adhesive and a process for producing the laminate is also disclosed.

### FIELD

The present disclosure relates to a retort adhesive composition useful in a laminating process; and the preparation of such retort adhesive composition. More specifically, the present disclosure relates to a solvent-based retort adhesive composition for use with laminate films, the adhesive composition exhibiting excellent adhesion performance, heat and chemical resistance, along with a very low level of migrated aromatic species.

### BACKGROUND

Adhesive compositions are useful for a wide variety of purposes. For instance, some adhesives are used to adhere two or more film layers of substrates together thereby forming composite films, i.e., laminates comprising the two or more film layers. Example of substrates typically include polyethylenes, polypropylenes, polyesters, polyamides, metals, papers, or cellophane and the like. The use of adhesives in different laminating end-use applications is generally known. For example, adhesives, are generally applied between laminating films, can be used in the manufacture of film/film and film/foil laminates used in the flexible packaging industry for packaging of foodstuffs, pharmaceuticals, and industrial consumables, especially for food packaging. Laminating adhesives can be classified generally into three categories: (1) solvent-based laminating adhesives, (2) solventless laminating adhesives, and (3) water-based laminating adhesives. The performance of an adhesive varies by category and by the application in which the adhesive is applied. Within the solvent-based category of laminating adhesives, solvent-based polyurethane has been widely used to achieve relatively good heat, moisture, and chemical resistance.

Within the category of solvent-based laminating adhesives, there are many varieties; and one particular variety includes multi-component polyurethane-based laminating adhesives; and more specifically a two-component adhesive. Typically, a two-component polyurethane-based laminating adhesive includes a first component comprising an isocyanate and/or a polyurethane prepolymer and a second component comprising one or more polyols. A polyurethane prepolymer can be obtained by the reaction of a polyisocyanate with a polyether polyol and/or polyester polyol. The second component comprises polyether polyols and/or polyester polyols. Each component can optionally include one or more additives. Common solvents used in such systems include methyl ethyl ketone, ethyl acetate, toluene, and the like, all of which must be moisture-free to prevent premature reaction of the isocyanate groups of the polyurethane.

The two components (i.e., the isocyanate and polyol components) of the adhesive composition are combined in a predetermined ratio, thereby forming an adhesive composition. The adhesive composition, carried in a solvent, is then applied on a film/foil substrate. The solvent is evaporated from the applied adhesive composition. Another film/foil substrate is then brought into contact with the other substrate, forming a curable laminate structure. The laminate structure is cured to bond the two substrates together.

Solvent-based adhesive compositions can be used in high-performance laminate applications (e.g., retort, hot-fill, boil-in-bag, etc.). For example, in retort flexible package applications, the retort flexible packages offer several benefits, such as (1) consumer convenience, (2) a long shelf life of food packed in the packages, and (3) preservation of the original flavor of the packed food. Retort flexible packages such as retort pouches are commonly constructed with multilayer lamination structures, such as a three-ply structure or a four-ply structure. The three-ply structure generally includes, for example, an outside layer of polyethylene terephthalate (PET), a middle layer of a metal foil (e.g., aluminum), and an inside layer of casted polypropylene (CPP); and the three-ply structure is generally indicated as PET//Foil//CPP. The four-ply structure generally includes, for example, an outside layer of PET, a first top middle layer of a metal foil, a second bottom middle layer of Nylon, and an inside layer of CPP; and the four-ply structure is generally indicated as PET//Foil//Nylon//CPP. A laminating adhesive is applied to the structures to bond the different layers together. The laminating adhesives used for retort flexible package applications must not only meet the extreme performance requirements at high temperature in the presence of highly acidic and fatty food, such as at a temperature of 121 degrees Celsius (° C.) for 1 hour (hr) or 132° C. for 30 minutes (min); but the laminating adhesives must also meet very strict regulatory standards such as the regulations promulgated by the Federal Department of Administration (FDA) and the European Union (EU).

The known retort adhesives are typically based on aliphatic isocyanate, which are compliant with global food regulation for retort application, exhibit excellent adhesion, but the curing of such aliphatic-based isocyanate adhesives is very slow, such as being curable above 40° C. for at least 10 days, before packaging foodstuff in packages made using the known laminating adhesives. It is well known that aromatic isocyanate-based adhesives can be cured fast, but these adhesives cannot meet the regulatory requirements due to the high level of migrated aromatic species. Thus, a need exists for a high performing retort adhesive with excellent adhesion performance, fast curing, and a very low level of migrated species.

### DETAILED DESCRIPTION

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1 to 7 above includes subranges 1 to 2; 2 to 6; 5 to 7; 3 to 7; 5 to 6; etc.).

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or” unless stated otherwise, refers to the listed members individually as well as in any combination. Use of the singular includes use of the plural and vice versa.

An “isocyanate” is a chemical that contains at least one isocyanate group in its structure. An isocyanate group is represented by the formula: —N═C═O or abbreviated as “NCO”. An isocyanate that contains more than one, or at least two, isocyanate groups is a “polyisocyanate.” An isocyanate that has two isocyanate groups is a diisocyanate and an isocyanate that has three isocyanate groups is a triisocyanate, etc. An isocyanate may be aromatic or aliphatic.

A “polyisocyanate” is a molecule that contains at least two isocyanate groups.

A “polyether” is a compound containing two or more ether linkages in the same linear chain of atoms.

A “polyester” is a compound containing two or more ester linkages in the same linear chain of atoms.

A “polyol” is an organic compound containing multiple hydroxyl (OH) groups. In other words, a polyol contains at least two OH groups. Nonlimiting examples of suitable polyols include diols having two OH groups, triols having three OH groups, and tetraols having four OH groups.

A “polyester polyol” is a compound that contains a polyester and a hydroxyl functional group in the backbone structure of the compound.

A “polyether polyol” is a compound that contains a polyether and a hydroxyl functional group in the backbone structure of the compound.

A “film,” including when referring to a “film layer” in a thicker article, unless expressly having the thickness specified, includes any thin, flat extruded or cast thermoplastic article having a generally consistent and uniform thickness of about 0.5 millimeters (mm) (20 mils) or less in one dimension.

A “polymer film” is a film that is made of a polymer or a mixture of polymers. The composition of a polymer film is typically, 80 percent by weight (wt %) of one or more polymers.

A “polymer” is a polymeric compound prepared by polymerizing monomers, whether of the same or a different type. The generic term polymer thus embraces the term “homopolymer” (employed to refer to polymers prepared from only one type of monomer, with the understanding that trace amounts of impurities can be incorporated into the polymer structure), and the term “interpolymer,” which includes copolymers (employed to refer to polymers prepared from two different types of monomers), terpolymers (employed to refer to polymers prepared from three different types of monomers), and polymers prepared from more than three different types of monomers. Trace amounts of impurities, for example, catalyst residues, may be incorporated into and/or within the polymer. It also embraces all forms of copolymer, e.g., random, block, etc. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A solvent based adhesive is disclosed comprising at least one isocyanate component and at least one isocyanate reactive component. The isocyanate component contains a blend of at least one aromatic-based isocyanate with free monomeric isocyanate less than 1 wt. % and at least one aliphatic-based isocyanate. The isocyanate reactive component comprises at least one phosphate ester polyol. A process for producing a laminate product using the above adhesive is also disclosed.

The isocyanates in the isocyanate component can be, for example, an isocyanate monomer, a polyisocyanate (e.g. dimers, trimers, etc.) an isocyanate prepolymer, and mixtures of two or more of the preceding. A “polyisocyanate” is any compound that contains two or more isocyanate groups.

The aromatic-based isocyanates useful in the present disclosure can include, for example, one or more polyisocyanate compounds including, but are not limited to, for example 1,3- and 1,4-phenylene diisocyanate; 1,5-naphthylene diisocyanate; 2,4′-diphenylmethane diisocyanate (2,4′-MDI); 4,4′-diphenylmethane diisocyanate (4,4′-MDI); 3,3′-dimethyl-4,4′-biphenyldiisocyanate (TODI) and isomers thereof; polymeric isocyanates; and mixtures of two or more thereof.

Exemplary of some of the commercial aromatic-based components useful in the present disclosure can include, for example, ISONATE™ 125 M, ADCOTTE™ L76-204, COREACTANT CT™, and CATALYST F™, available from The Dow Chemical Company; DESMODUR™ E 2200/76, available from The Covestro Company; and mixtures thereof.

The aliphatic-based isocyanate in the isocyanate component can be aliphatic polyisocyanates having 3 carbon atoms (C) to 16 C, or 4 C to 12 C in the linear or branched alkylene residue. Also suitable for use in the present disclosure are cycloaliphatic polyisocyanates including, for example, cycloaliphatic polyisocyanates having 4 C to 18 C, or 6 C to 15 C in the cycloalkylene residue.

Examples of suitable aliphatic polyisocyanates and cycloaliphatic polyisocyanates useful in the present disclosure include, but are not limited to, cyclohexane diisocyanate, methylcyclohexane diisocyanate, ethylcyclohexane diisocyanate, propylcyclohexane diisocyanate, methyldiethylcyclohexane diisocyanate, propane diisocyanate, butane diisocyanate, pentane diisocyanate, hexane diisocyanate, heptane diisocyanate, octane diisocyanate, nonane diisocyanate, nonane triisocyanate, such as 4-isocyanatomethyl-1,8-octane diisocyanate (TIN), decane di- and triisocyanate, undecane di- and triisocyanate and dodecane di- and triisocyanate, hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI), xylylene diisocyanate (XDI), 1,4- or 1,3-bis(isocyanatomethyl)cyclohexane (H₆XDI), tetramethylxylylene diisocyanate, and dimers, trimers, derivatives and mixtures of the of two or more thereof. Suitable aliphatic polyisocyanates and cycloaliphatic polyisocyanates useful in the present disclosure also include, for example, XDI-based polyisocyanate, H₆XDI-based polyisocyanate, XDI isocyanurate, HDI-based polyisocyanate, H₁₂MDI-based polyisocyanate, HDI isocyanurate, and mixtures of two or more thereof.

Exemplary of some of the commercial products of aliphatic-based components useful in the present disclosure include, for example, TAKENATE™ D-110N and TAKENATE™ D-120N, available from Mitsui Chemical; Desmodur™ N 3200 and Desmodur™ Quix 175, available from The Coverstro Company; and mixtures thereof.

Additional isocyanate-containing compounds suitable for use according to the present disclosure include, but are not limited to, polyisocyanate of 4-methyl-cyclohexane 1,3-diisocyanate, 2-butyl-2-ethylpentamethylene diisocyanate, 3(4)-isocyanatomethyl-1-methylcyclohexyl isocyanate, 2-isocyanatopropylcyclohexyl isocyanate, 2,4′-methylenebis(cyclohexyl) diisocyanate, 1,4-diisocyanato-4-methyl-pentane, and mixtures of two or more thereof.

The phosphate ester in the isocyanate reactive component can be selected, for example, from a phosphate ester compound having the following chemical structure:

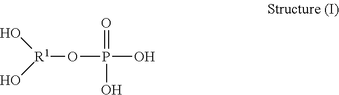

where R¹ is any organic group. In addition to the pendant groups shown in Structure (1), R¹ may or may not have one or more additional pendant —OH groups, and R¹ may or may not have one or more additional pendant groups of Structure (I). Any two or more of the —OH groups and the group(s) of Structure (I) may or may not be attached to the same atom of R¹. Each —OH group and each group of Structure (I) can be attached to a separate atom of R¹.

A convenient way to characterize R¹ is to describe the compound having the following Structure (II):

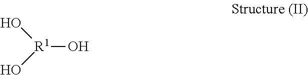

where R¹ is the same as in Structure (I). The compound having Structure (II) is referred to herein as a “precursor polyol.”

Suitable precursor polyols can have number average Mw of 90 g/mol or higher, 200 g/mol or higher, or 400 g/mol or higher. Suitable precursor polyols can have number average Mw of 4,000 g/mol or lower, 2,000 g/mol or lower, 1,200 g/mol or lower, 900 g/mol or lower, or 500 g/mol or lower. Suitable precursor polyols can have number average Mw from 200 g/mol to 4,000 g/mole, from 400 g/mol to 2,000 g/mol, from 400 g/mol to 1,200 g/mol, or from 400 g/mol to 900 g/mol.

Suitable precursor polyols can be alkyl higher polyols, monosaccharides, disaccharides, and compounds having the following Structure (III):

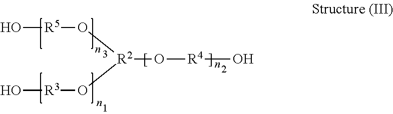

where each of R², R³, R⁴, and R⁵ is, independent of the other, any organic group; each of n₁, n₂, and n₃ is, independent of the other, an integer from 0 to 10. In addition to the pendant groups shown in Structure (III), R² may or may not have one or more additional pendant groups. It is further understood that any two or more of the pendant groups may or may not be attached to the same atom of R². A mixture of compounds having Structure (III) is present, where the compounds of Structure (III) differ from each other in the value of one or more of n₁, n₂, and n₃. Such mixtures are described herein by stating a non-integer value for the parameter n₁, n₂, or n₃, where the non-integer value represents the number average of that parameter. When it is desired to assess the molecular weight of such a mixture, the number-average molecular weight is used.

Among precursor polyols having Structure (III), each pendant group can be attached to a separate atom of R². Among precursor polyols having Structure (III), one or more of R³, R⁴, and R⁵ can be a hydrocarbon group having 1 C to 4 Cs, 2 Cs to 3 Cs or 3 Cs. Among precursor polyols having Structure (III), one or more of R³, R⁴, or R⁵ can be an alkyl group, which may be linear or cyclic or branched or a combination thereof; one or more of R³, R⁴, or R⁵ can be a linear or branched alkyl group; and one or more of R³, R⁴, or R⁵ can be a branched alkyl group. R³, R⁴, or R⁵ can be identical to each other.

Among precursor polyols having Structure (III), one or more of n₁, n₂, and n₃ can be from 0 to 8. Among precursor polyols having Structure (III), one or more of n₁, n₂, and n₃ can be 1 or more. Among precursor polyols having Structure (III), one or more of n₁, n₂, and n₃ can be 6 or less. Among precursor polyols having Structure (III), n₁, n₂, and n₃ can be the same.

The group of precursor polyols having Structure (III) can be compounds in which each of R², R³, R⁴, and R⁵ is an alkyl group; such precursor polyols are known herein as alkoxylated alkyl triols. In a triol, when at least one of n₁, n₂, and n₃ is 1 or more and R² has the following Structure (IV):

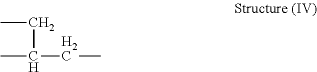

then the triol is known herein as an alkoxylated glycerol. In alkoxylated triols, when each of R³, R⁴, and R⁵ is a branched alkyl group with exactly 3 C, the alkoxylated triol is known herein as a propoxylated triol. A propoxylated triol in which R² has Structure (IV) is known herein as propoxylated glycerol.

Among precursor polyols that are alkyl higher polyols, can be compounds with 10 C or fewer carbon atoms; compounds with 6 C or fewer carbon atoms; compounds with 3 or fewer carbon atoms; or glycerol.

Precursor polyols can be alkyl higher polyols and compounds having Structure (III). It is noted that, if n₁ is equal to (=) n₂=n₃=0 and if R² is either an alkyl group or an alkyl group having hydroxyl groups, then the compound having Structure (IV) is an alkyl higher polyol.

The group of precursor polyols can be alkyl triols and alkoxylated alkyl triols. Among these compounds, are glycerol and alkoxylated glycerols. Among alkoxylated glycerols, are propoxylated glycerols.

Another class of suitable phosphate ester compounds useful in the present disclosure includes compounds that contain urethane linkages. Phosphate ester compounds containing urethane linkages are made by reacting one or more suitable phosphate-functional polyol with one or more polyisocyanate, one or more diisocyanates can also be included. The amount of polyisocyanate can be kept low enough so that some or all of the reaction products are phosphate-functional polyols. Alternatively, the polyol may be first reacted with the polyisocyanate to make an —OH terminated prepolymer which is then reacted with polyphosphoric acid. Phosphate ester compounds with urethane linkages include those compounds having a number average Mw in the range of 1,000 g/mol to 6,000 g/mol, in the range of 1,200 g/mol to 4,000 g/mol, and in the range of 1,400 g/mol to 3,000 g/mol.

The phosphate ester compound can be the reaction product of reactants including a precursor polyol and a phosphoric-type acid, where the resulting phosphate ester compound has the chemical structure of Structure (I).

The amounts of phosphoric-type acid and precursor polyol are chosen to determine the ratio of Mₚ:Mₓ as follows: M_{hy}=the number of hydroxyl groups per molecule of the precursor polyol; Nₓ=M_{hy}−2; Mₓ=(the moles of precursor polyol)×(Nₓ); and Mₚ=the moles of phosphorous atoms contained in the phosphoric-type acid.

In general, the ratio of Mₚ:Mₓ is 0.1:1 or higher, 0.2:1 or higher, 0.5:1 or higher, or 0.75:1 or higher. The ratio of Mₚ:Mₓ can be 1.1:1 or lower.

Generally, the weight ratio of phosphoric-type acid to precursor polyol is 0.005:1 or higher, 0.01:1 or higher, or 0.02:1 or higher. The weight ratio of phosphoric-type acid to precursor polyol can be 0.3:1 or lower, or 0.2:1 or lower, or 0.12:1 or lower.

The phosphoric-type acid can contain polyphosphoric acid. And, in general, the amount of polyphosphoric acid in the phosphoric-type acid is, by weight based on the weight of the phosphoric-type acid, 75 wt % or more, 80 wt % or more, or 90 wt % or more. Polyphosphoric acid is available in various grades; each grade is characterized by a percentage. To determine the grade, it is first recognized that pure monomeric orthophosphoric acid, the content of phosphorous pentoxide is considered to be 72.4%. Any grade of polyphosphoric acid can also be analyzed, to consider that one mole of polyphosphoric acid (formula weight labeled “Fppa”) contains the number of moles of phosphorous pentoxide labeled “Nppo,” and the phosphorous pentoxide percentage (“PCppo”) is given by PCppo=(Nppo×142)/Fppa, expressed as a percentage. Then, the grade of that polyphosphoric acid is the ratio, expressed as a percentage: Grade=PCppo/72.4.

The polyphosphoric acid used can have a grade of 100% or higher, or 110% or higher. The polyphosphoric acid used can have a grade of 150% or lower, or 125% or lower.

Further information about suitable phosphate esters and the preparation of such suitable phosphate esters can be found, for example, in PCT Publication No. WO/2015/168670.

The amount of the phosphate ester polyol used in the isocyanate reactive component can be from 0.1 wt. % to 1 wt. %, 1 wt. % to 5 wt. %, 5 wt. % to 10 wt. %, 10 wt. % to 15 wt. %, or 15 wt. % to 20 wt. % based on the dry weight of the isocyanate reactive component.

The disclosed solvent-based adhesive compositions can contain one or more phosphorous-free polyols in addition to the one or more phosphate-functional polyols. The isocyanate reactive component can include one or more polyester polyols. The polyester polyol, can have a molecular weight of >2.

Suitable polyester polyols useful in the present disclosure include, but are not limited to, for example, aliphatic polyester polyols; aromatic polyester polyols; copolymers of aliphatic and aromatic polyester polyols; polycarbonate polyols; polycaprolactone polyols; and mixtures thereof. These polyester polyols: are the reaction products of polybasic acids and polyhydric alcohols; or are the reaction of phosgene or a carbonate monomer with a polyhydric alcohol; or are produced via ring opening polymerization of cyclic ester compounds.

Exemplary of suitable polybasic acids useful in the present disclosure include succinic acid, adipic acid, azelaic acid, sebacic acid, dodecanedicarboxylic acid, maleic anhydride, fumaric acid, 1,3-cyclopentane-dicarboxylic acid, 1,4-cyclohexanedicarboxylic acid, terephthalic acid, isophthalic acid, phthalic acid, 1,4-naphthalenedicarboxylic acid, 2, 5-naphthalenedicarboxylic acid, 2,6-naphthalenedicarboxylic acid, naphthalic acid, biphenyldicarboxylic acid, 1,2-bis(phenoxy)ethane-p,p′-dicarboxylic acid, and anhydrides or ester-forming derivatives of these dicarboxylic acids; and p-hydroxybenzoic acid, p-(2-hydroxyethoxy)benzoic acid, and ester-forming derivatives or dimer acids of these dihydroxycarboxylic acids; and mixtures thereof. These polybasic acids may be used alone or in a combination of two or more polybasic acids.

Any known polyhydric alcohol can be used according to this disclosure. Non-limiting examples of suitable polyhydric alcohols useful in the present disclosure include: glycols such as ethylene glycol, propylene glycol, 1,3-propanediol, 1,4-butanediol, 1,5-pentanediol, 3-methyl-1,5-pentanediol, 1,6-hexanediol, neopentylglycol, methylpentanediol, dimethylbutanediol, butylethylpropanediol, diethylene glycol, triethylene glycol, tetraethylene glycol, dipropylene glycol, tripropylene glycol, bishydroxyethoxybenzene, 1,4-cyclohexanediol, 1,4-cyclohexane-dimethanol, triethylene glycol, polycaprolactone diol, dimer diol, bisphenol A, and hydrogenated bisphenol A; polyesters produced through ring opening polymerization of cyclic ester compounds such as propiolactone, butyrolactone, s-caprolactone, 8-valerolactone, and β-methyl-δ-valerolactone; and polyethers produced from addition polymerization of one or more monomers including ethylene oxide, propylene oxide, butylene oxide, styrene oxide, epichlorohydrin, tetrahydrofuran, and cyclohexylene in the usual manner with the aid of one or more compounds containing two active hydrogen atoms as an initiator, such as ethylene glycol, diethylene glycol, triethylene glycol, propylene glycol, trimethylene glycol, 1,3-butanediol, 1,4-butanediol, 1,6-hexanediol, and neopentyl glycol; and mixtures thereof. These polyhydric alcohols may be used alone or in a combination of two or more polyhydric alcohols.

The amount of the polyester polyol used in the isocyanate reactive component can be over 20 wt. %, over 30 wt. %, over 40 wt. %, over 50 wt. %, over 60 wt. %, or over 70 wt. % based on the dry weight of the polyol component.

The adhesive composition of the present disclosure generally includes at least one solvent. Suitable solvents can include but are not limited to, ethyl acetate, methyl ether ketone, toluene, and mixtures thereof.

The amount of the solvent, used in the present disclosure process can be, for example, from 20 wt % to 90 wt %, from 30 wt % to 80 wt %, or from 40 wt % to 70 wt % based on the total amount of the components in the adhesive composition.

The adhesive composition of the present disclosure can include one or more additional optional conventional ingredients or additives including but not limited to, catalysts, tackifiers, plasticizers, rheology modifiers, adhesion promoters, antioxidants, fillers, colorants, pigments, surfactants, polymers (including, for example, thermoplastic resins other than those discussed herein above), dehydrating agents (including, for example, silanes), benzoyl chloride, other polyols (including, for example, fatty polyols), ultraviolet indicators, and combinations of two or more of these.

The adhesive composition may include, for example, an adhesion promoter. Nonlimiting examples of suitable adhesion promoters include coupling agents such as a silane coupling agent, a titanate coupling agent, and an aluminate coupling agent; epoxy resin, phosphoric acid, polyphosphoric acid, and phosphate esters.

Examples of the silane coupling agent useful in the present disclosure include, but are not limited to, aminosilanes such as γ-aminopropyltriethoxysilane, γ-aminopropyl-trimethoxysilane, N-β(aminoethyl)-γ-aminopropyltrimethoxysilane, N-β(aminoethyl)-γ-aminopropyltrimethyl dimethoxysilane, and N-phenyl-γ-aminopropyltrimethoxysilane; epoxysilanes such as β-(3,4-epoxycyclohexyl)-ethyltrimethoxysilane, γ-glycidoxypropyl-trimethoxysilane, and γ-glycidoxypropyltriethoxysilane; vinylsilanes such as vinyl tris(β-methoxyethoxy)silane, vinyltriethoxysilane, vinyltrimethoxysilane, and γ-methacryloxypropyltrimethoxysilane; hexamethyldisilazane; γ-mercaptopropyl-trimethoxysilane; and mixtures thereof.

Examples of the titanate coupling agent useful in the present disclosure include, but are not limited to, tetraisopropoxy titanium, tetra-n-butoxy titanium, butyl titanate dimer, tetrastearyl titanate, titanium acetylacetonate, titanium lactate, tetraoctyleneglycol titanate, titanium lactate, tetra stearoxy titanium; and mixtures thereof.

Examples of the epoxy resin useful in the present disclosure include, but are not limited to, a variety of readily available epoxy resins such as bisphenol A-epichlorohydrin (epi-bis) type epoxy resin, novolak type epoxy resin, β-methylepichlorohydrin type epoxy resin, cyclic oxirane type epoxy resin, glycidyl ether type epoxy resin, glycidyl ester type epoxy resin, polyglycol ether type epoxy resin, glycol ether type epoxy resin, epoxidation fatty acid ester type epoxy resin, polycarboxylic acid ester type epoxy resin, aminoglycidyl type epoxy resin, resorcin type epoxy resin; and mixtures thereof.

The adhesion promoter can be a phosphate ester compound or an epoxy silane ((3-glycidyloxypropyl)-trimethoxysilane). Phosphoric acid can be incorporated in the polyol component while epoxy silane can be incorporated in the isocyanate component. Both epoxy silane and phosphoric acid can be incorporated in the polyol component.

The average functionality of the adhesive composition (i.e., the isocyanate component together with the polyol component), excluding non-reactive components such as solvents, can be from 2 to 3.

The amount of optional components when used can be from 0 wt % to 15 wt %, from 0.01 wt % to 10 wt % or from 0.1 wt % to 5 wt % based on the total amount of components in the adhesive composition.

It is contemplated that two components, an isocyanate component and a polyol component, are employed in the present disclosure. It is also contemplated that the isocyanate component and the polyol component of the disclosed adhesive composition can be made separately and, if desired, stored until it is desired to use the adhesive composition. The process of producing the adhesive composition includes mixing the isocyanate and polyol components described above to form a curable adhesive composition. Both the isocyanate component and the polyol component can each be liquid at 25° C. When it is desired to use the adhesive composition, the isocyanate component and the polyol component are brought into contact with each other and mixed together, typically at a stoichiometric ratio (NCO/OH) between 1 and 2.5. It is contemplated that when these two components are brought into contact, a curing reaction begins in which the isocyanate groups react with the hydroxyl groups to form urethane links. The adhesive composition formed by bringing the two components into contact can be referred to as a “curable mixture”.

To form the adhesive composition, mixing of the two components may take place at any suitable time in the process of forming the adhesive composition and applying the adhesive to a substrate, such as before, during, or as a result of the application process. All of the present steps may be carried out under ambient, room temperature conditions. As desired, heating or cooling may be employed. The mixing can be carried out using a suitable conventional mixer, such as using an electrically, pneumatically, or an otherwise powered mechanical mixer.

The process for preparing the solvent-based adhesive composition of the present disclosure includes, for example, the steps of (1) providing the isocyanate component; (2) providing the polyol component; (3) mixing the two components to form a resin mixture; (4) diluting the resin mixture in a solvent to form a diluted resin mixture having an application solid content of from 20 wt % to 55 wt %, from 30 wt % to 45 wt %, or from 35 wt % to 40 wt % based on the total weight of the diluted resin mixture; and (5) removing the solvent from the composition to form the adhesive composition before the composition is applied to a substrate and before the composition is cured.

Some of the advantageous properties exhibited by the solvent-based adhesive composition of the present disclosure include, for example, (1) good adhesion performance; (2) fast curing; and (3) a low level of migrated undesirable aromatic amines such as MDA and TDA into food packed in packages using the adhesive.

For example, the bond of the adhesive after 1 hr of retort testing at 121° C. can be greater than 3N/15 mm, 4 N/15 mm, 5 N/15 mm, 6 N/15 mm, or 7 N/15 mm. The bond can be dependent on the type of film substrate used and the films can be bonded where after testing the substrates failure mode occurs before the bond.

The curing time of the adhesive can be from 1 day to 8 days, from 1 day to 7 days, or from 2 days to 7 days.

A process of forming a laminate using the adhesive composition of the present disclosure is also disclosed herein. The adhesive composition, such as the adhesive composition discussed above, can be in a liquid state at 25° C. Even if the composition is solid at 25° C., it is acceptable to heat the composition as necessary to transform the composition into a liquid state. Solvent is added to the mixed adhesive composition until the desired solids content is reached. A solids content of 25% or greater can be used.

The adhesive composition of the present disclosure is useful for bonding substrates together; and the adhesive composition can be used on a wide variety of a single suitable substrate or a plurality of suitable substrates. The substrates may be similar materials or dissimilar materials. For example, the substrate may be selected from high, low or medium density plastics (e.g., of a type selected from polystyrene, polyethylene, ABS, polyurethane, polyethylene terephthalate, polybutylene terephthalate, polypropylene, polyphenylene, polycarbonate, polyacrylate, polyvinyl chloride, polysulfone, and mixtures thereof), paper, wood and reconstituted wood products, polymer coated substrates, wax coated paperboard, cardboard, particle board, textiles, leather, and metal (e.g., aluminum, ferrous as well as other non-ferrous), metallized plastics (e.g., metallized plastic film) or the like.

Wet and dry bond lamination of a plurality of substrate layers is possible. The adhesive composition can be applied to desired substrates using conventional application techniques such as rotogravure printing, flexographic printing, conventional or airless spray, roll coating, brush coating, wire wound rod coating, knife coating, or coating processes such as curtain-, flood-, bell-, disc-, and dip-coating processes. Coating a substrate with the adhesive composition may be done over the entire surface of the substrate or to a portion of the substrate's surface, such as along an edge, or at intermittent locations. Once applied to the substrate, the adhesive composition is dried, such as by application of heat and air flow, or some other suitable conventional approach for removing substantially all remaining solvent present in the adhesive composition.

A laminate comprising the solvent-based adhesive composition of the present disclosure can be formed by applying the adhesive to at least one of two different substrates and combining the substrates together such that the adhesive is disposed between the surfaces of the two substrates; and then curing the adhesive to form a bond between the two substrates. The substrates can include, for example, two separate films; and each of the films can be made of a different material or of the same material. Generally, a layer of the adhesive composition is applied to a surface of a film. The thickness of the layer of the curable adhesive composition mixture applied to a surface of a film is from 1 micron (μm) to 5 μm. As used herein, a “film” is any structure that is 0.5 mm or less in one dimension of the structure; and is 1 centimeter (cm) or more in both of the other two dimensions of the structure.

A surface of another film is brought into contact with the layer of the curable mixture to form an uncured laminate. The curable mixture is then cured or allowed to cure. The uncured laminate may be subjected to pressure, for example by passing through nip rollers, which may or may not be heated. The uncured laminate may be heated to speed the cure reaction.

Suitable substrates used to form the laminate structure include films such as paper, woven and nonwoven fabric, polymer films, metal foil, metal-coated (metallized) polymer films, and combinations thereof. The substrates are layered to form a laminate structure, with an adhesive composition according to the present disclosure adhering one or more of the substrates together. Films can optionally have a surface on which an image is printed with ink.

The ink may be in contact with the adhesive composition. The films can be polymer films, metal-coated polymer films, or polymer films. A “polymer film” is a film that is made of a polymer or mixture of polymers. The composition of a polymer film is, typically, 80 wt % or more of one or more polymers.

The adhesive composition is particularly attractive for packaging and sealing applications. For example, a plastic film, metal film, or metallized plastic film can be laminated (e.g., over all of its surface or at least a portion of its surface, such as along its edges, or at intermittent locations) with the adhesive composition of the present disclosure to form a laminate. The laminate can be used, to form a pouch made of at least two layers of film with the adhesive bonded in-between the two film layers. Food may be packaged for retort preparation, or the resulting laminate might be used for sealing or packaging some other article.

### EXAMPLES

The following examples are presented to further illustrate the present disclosure in detail but are not to be construed as limiting the scope of the claims. Unless stated to the contrary, implicit from the context, or customary in the art, all parts and percentages are based on weight and all test methods are current as of the filing date of this disclosure.

Various raw materials or ingredients used in the Inventive Examples (Inv. Ex.) and the Comparative Examples (Comp. Ex.) are explained in Table I as follows:

TABLE 1
Raw Materials

| Ingredient | Brief Description | Supplier |
|---|---|---|
| ADCOTETM 545E | POLYESTER POLYOL WITH | DOW |
| | AN OHN OF ABOUT 10 | |
| | KOH/MG | |
| ADCOTETM 536A | AN NCO-TERMINATED | DOW |
| | ISOCYANATE BASED ON MDI | |
| | ISOCYANATE WITH FREE | |
| | MONOMERIC MDI OF OVER | |
| | 1% | |
| ADCOTETM 522 | AN NCO-TERMINATED | DOW |
| | ISOCYANATE BASED ON MDI | |
| | ISOCYANATE WITH FREE | |
| | MONOMERIC MDI OF OVER | |
| | 1% | |
| INTERMEDIATE 1 | AN NCO-TERMINATED | DOW |
| | ISOCYANATE BASED ON MDI | |
| | ISOCYANATE WITH FREE | |
| | MONOMERIC MDI OF 0.1% | |
| ADCOTETM 536B | SOLVENT BASED POLYOL | DOW |
| ISONATETM | AN NCO-TERMINATED MDI | DOW |
| 125M MDI | ISOCYANATE | |
| VORANOL PUP | POLYPROPYLENE GLYCOL | DOW |
| 2025 POLYOL | | |
| VORANOL ™ CP | POLYETHER POLYOL WITH | DOW |
| 450 | AVERAGE MOLECULAR | |
| | WEIGHT OF ABOUT 450 AND | |
| | A FUNCTIONALITY OF 3 | |
| POLYPHOSPHORIC | 115% POLYPHOSPHORIC ACID | SIGMA |
| ACID | | ALDRICH |
| MOR-FREETM C33 | HDI-BASED ALIPHATIC | DOW |
| | ISOCYANATE WITH 100% | |
| | SOLIDS | |
| TAKENATETM | XDI-BASED ALIPHATIC | THE |
| D-110 N | ISOCYANATE WITH A SOLID | MITSUI |
| | CONCENTRATION OF 75 WT % | CHEMICAL |
| | | COMPANY |
| ADOCTETM 811AEA | HIGH MOLECULAR WEIGHT | DOW |
| | POLYESTER POLYOL | |
| COREACTANT TM | ALIPHATIC ISOCYANATE | DOW |
| 9L10 | | |

TABLE 2
Adhesive formulation

| | Formulation (parts) | | | | | | |
|---|---|---|---|---|---|---|---|
| | Inventive | Inventive | Comparative | Comparative | Comparative | Comparative | Comparative |
| Ingredient | Sample 1 | Sample 2 | Sample 1 | Sample 2 | Sample 3 | Sample 4 | Sample 5 |
| Part A (OH | | | | | | | |
| side) | | | | | | | |
| ADCOTE 545 E | 98 | 98 | 98 | 98 | 98 | | |
| Mor-Free 88-138 | 2 | 2 | 2 | 2 | 2 | | |
| ADCOTE | | | | | | | 100 |
| 811AEA | | | | | | | |
| ADCOTE 536B | | | | | | 11 | |
| Part B (NCO | | | | | | | |
| side) | | | | | | | |
| XSZ 52116 | 10 | 13.2 | | | | | |
| ADCOTE 811B | 10 | 8.8 | | 13 | | | |
| MOR-FREE C33 | | | 6 | | | | |
| ADCOTE 522 | | | | | 115 | | |
| ADCOTE 536A | | | | | | 100 | |
| Coreactant 9L10 | | | | | | | 8 |
| Solvent | | | | | | | |
| Ethyl Acetate | 140 | 145 | 116 | 92 | 210 | 116 | 110 |

### Preparation of Intermediate 1

673 g of ISONATE™ 125M MDI are melted in a 40° C. oven and added to a 3 L round bottom flask pre-heated to 60° C. under N₂ atmosphere. 1327 g of VORANOL PUP 2025 polyol are pre-heated to 50° C. and added to the ISONATE™ 125M MDI. The mixture is stirred continuously as all exothermic phenomena are completed and then while stirring is continued heated to between 80-85° C. The mixture is then stirred continuously for 1.5 hours while the temperature is maintained at 80° C. Residual % NCO is checked via titration until the measured value is 8.4 close to the theoretical value 8.5. The solution is then cooled to between 40-50° C. and transferred to metallic cans. The cans are filled with nitrogen to prevent reaction with moisture and stored in the freezer until distilled.

The evaporator temperature, condenser temperature, pressure, feed rate, and wiper speed of a laboratory-scale UIC KDL 5 distillation device is set to 175° C., 45° C., 0.04 mbar, 0.6 to 1.2 kg/hour, and 360 U/minute respectively. In the laboratory a single pass is used, but it is likely that upon scale up two or more passes may be needed. The NCO % of the final prepolymer should be 2.82, viscosity should be 15560 mPas, and the residual free MDI monomer should be 0.1%.

Residual MDI is reported as weight % based on the weight of the prepolymer. Viscosity is measured at 25° C. with a Brookfield viscometer model DVIII, following ASTM method D2196, using the spindle 4 and 20 rpm.

### General Preparation of Phosphate Ester Compounds

A 1 liter (L) multi-neck round bottom flask is dried in an oven, flushed with dry nitrogen (N₂) for 30 min, then charged with 150 grams (g) of VORANOL™ CP 450 polyether polyol and placed under an N₂ sweep of 70 milliliters per minute (mL/min). A syringe is loaded with 4 g of 115% Polyphosphoric 20 acid (PPA). The PPA is added dropwise to the polyether polyol with strong agitation. A minimal temperature increase should be observed. The reactor contents are heated to 100° C. for 1 hr then cooled to 45° C. Then, 40 g of ethyl acetate are added to the reactor, followed by a slow addition of 50 g of ISONATE™ 125M diisocyanate. A significant exotherm is controlled with the application of an ice batch to keep the reaction pot below 75° C. and development of a yellow to amber color should be observed. The reactor is then maintained at 65° C. for 1 hr, at which point the contents are cooled and packaged. The product should have the following properties: 76.0% solids, a hydroxyl number (OHN) of 112 mg KOH/g, acid value (AV) of 19.0 mg KOH/g, and a viscosity at 25° C. of 1,665 millipascals-seconds (mPa·s).

### General Procedure for Preparing the Isocyanate—Reactive Component

The polyester polyol, and the phosphate ester polyol are charged into a glass reactor. The reactor is heated to about 40° C. and the resulting mixture is stirred for about 30 min at 40° C. The resulting mixture is then packaged and stored.

### General Procedure for Preparing the Adhesive Formulation

The pertinent ingredients for preparing the adhesive formulations including the isocyanate-reactive component, the isocyanate component and solvent are described in Table 2.

Using the adhesive of Inventive Example 1 as a typical example for an adhesive formulation sample preparation, about 1,000 g of isocyanate-reactive component (Part A), about 200 g of isocyanate component (Part B) and about 1,400 g of ethyl acetate are loaded into a plastic container. The materials are mixed using a mechanical mixer at room temperature (about 25° C.) for 30 min to obtain the formulated adhesive of the Inventive Examples.

### General Procedure for Preparing Laminates

The laminates based on the solvent-based adhesives were produced via a Nordmeccania LABO COMBI™ 400 pilot coater at room temperature (about 25° C.) at a nip temperature of 180° F. and a two-minute drying temperature of 176° F. Polymer films were corona treated before lamination and an aluminum (Al) foil was used without corona treatment. The coat weight of each laminate was maintained at about 2.5 lbs/ream. The prepared laminates were subsequently cured in a controlled environment (e.g., at 25° C. and 50% relative humidity or 50° C. in a convection oven).

The Examples are prepared using films including a “Prelam” which is a 12 μm (48 gauge) polyester (“PET”) film laminated to a 0.00035 mil Al foil with ADCOTE™/Coreactant F at 3.26 g/m² (2.00 lbs/ream), commercially available from The Dow Chemical Company, and a cast polypropylene (“CPP”) film with a thickness of 65 μm, commercially available from Bipack Company.

### Bond Strength Measurement

Laminate samples are cut to 15 mm wide strips and pulled on a THWING ALBERT™ QC-3A peel tester equipped with a 50N loading cell at a rate of 4 inch/min. When the two films in the laminate separate, the average of the force during the pull is recorded. If one of the films stretches or breaks the maximum force or force at break is recorded. The values are the average of three separate sample strips.

### General Procedure for Preparing Pouches

Laminates are made from the Prelam//CPP as described above. One of the 9 inches×12 inches (23 cm×30.5 cm) sheets of laminate are folded over to give a double layer of about 9 inches×6 inches (23 cm×15.3 cm) such that the CPP film of one layer is in contact with the CPP film of the other layer. The edges of the folded laminate are trimmed on a paper cutter to give a folded piece of about 5 inches×7 inches (12.7 cm×17.8 cm). Two long sides and one short side of the folded piece are heat sealed at the edges to give a finished pouch with an interior size of 4 inches×6 inches (10.2 cm×15.2 cm). The heat sealing was done at 400° F. (204° C.) for 1 second (s) at a hydraulic pressure of 40 pounds per square inch (psi) (276 kilopascals [kPa]). Two or three pouches were made for each test.

### Retort Performance Testing

The pouches prepared as described above are filled through the open edge with 100 milliliters (mL)±5 mL of distilled water (DI water) or 1:1:1 sauce (blend of equal parts by weight of ketchup, vinegar, and vegetable oil). Splashing the filling onto the heat seal area should be avoided as this could cause the heat seal to fail during the test. After filling, the top of the pouch is sealed in a manner that minimizes air entrapment inside of the pouch. The seal integrity is inspected on all four sides of the pouches to ensure that there are no flaws in the sealing that would cause the pouch to leak during the test. Any defected pouches are discarded and replaced. In some cases, flaws in the laminate are marked to identify whether new additional flaws are generated during the testing.

The pouches, containing 1:1:1 sauce, are then placed in a STERIS autoclave set at 121° C. for 1 hr. The pouches are removed after retort and the extent of tunneling, blistering, de-lamination, or leakage is compared with any of the marked pre-existing flaws. The observations are recorded. The pouches are cut open, emptied, and rinsed with soap and water. One or more one-inch (2.54 cm) strips are cut from the pouches and the laminate bond strength is measured according to the standard bond strength test described above. This was done as soon as possible after removing the pouch contents. The interior of the pouches are examined visually and any visual defects are recorded.

### Retort Regulatory Sample Preparation

The pouches consisting of 30.8 square inches (in²) (198.7 square centimeters (cm²) of laminate each are filled with 100 mL 3% acetic acid per sample. The pouches are then transferred to the retort chamber where they are stored for 2 hr at 121° C. After testing and upon cooling to ambient temperature, the acetic acid is transferred to polyethylene bottles.

The acetic acid samples are extracted and prepared for analysis within days of preparation and analyzed via UV-Vis Spectroscopy ultra within 24 hr of preparation.

TABLE 2
Performance of Inventive and comparative samples

| | Inventive | Inventive | Comparative | Comparative | Comparative | Comparative |
|---|---|---|---|---|---|---|
| | Example 1 | Example 2 | Example 1 | Example 2 | Example 3 | Example 4 |
| Description | Foil/Inventive | Foil//Inventive | Foil/Comparative | Foil/Comparative | Foil/Comparative | Foil/Comparative |
| | Sample 1/CPP | Sample 2/CPP | Sample 1/CPP | Sample 2/CPP | Sample 3/CPP | Sample 4/CPP |
| Bond strength | 8.3, AT | 7.1, AT | 7.4, AT | 10.6, AT | 16.1, AT | 7.7, AT |
| before retort | | | | | | |
| testing (N/15 | | | | | | |
| mm) | | | | | | |
| Bond after | 5.2, AT | 4.3, AT | 4.6, AT | 4.9, AT | 5.5, AT | 0.2, DL |
| 121 C., water | | | | | | |
| for 1 hr | | | | | | |
| Testing (N/15 | | | | | | |
| mm) | | | | | | |
| Bond after | 4.3, AT | 4.2, AT | 4.1, AT | 6.1, AT | 3.2, AT | 0.1, DL |
| 121 C., 1:1:1 | | | | | | |
| sauce for 1 hr | | | | | | |
| Testing (N/15 | | | | | | |
| mm) | | | | | | |
| PAA level | 0.8 | 1.8 | 0^{[ ]} | 0^{[ ]} | 11.7 | 10.9 |
| after 121 C., 2 | | | | | | |
| hr Testing | | | | | | |
| (ppb) | | | | | | |

DL: Delaminated, the secondary film separated from the primary film
AT: Adhesive transfer (adhesive fails to adhere to the primary film and is transferred to the secondary film).

TABLE 3
Curing time of Inventive and comparative samples
Comparative sample 1 and 2 had no aromatic isocyanate in composition

| | Inventive | Inventive | | | | | |
|---|---|---|---|---|---|---|---|
| | Example | Example | Comparative | Comparative | Comparative | Comparative | Comparative |
| | 1 | 2 | Example 1 | Example 2 | Example 3 | Example 4 | Example 5 |
| Description | Foil/Inventive | Foil//Adhesive | Foil/Comparative | Foil/Comparative | Foil/Comparative | Foil/Comparative | Foil/Inventive |
| | Adhesive | B/CPP | Adhesive | Adhesive | Adhesive | Adhesive | Adhesive |
| | A/CPP | | C/CPP | D/CPP | E/CPP | F/CPP | G/CPP |
| Curing | 4 Days at | 4 Days at | 7 days@25 | 5 Days@25 | 2 Days@25 C. | 2 Days@25 C. | 10 |
| Time | 25 C. | 25 C. | C. | C. | | | Days@50 C. |

1. A solvent-based retort adhesive composition comprising:
a) at least one isocyanate component comprising a blend of at least one aromatic-based isocyanate with free monomeric isocyanate less than 1 wt. % and at least one aliphatic-based isocyanate
b) at least one NCO reactive component comprising a phosphate ester polyol and at least one polyester polyol having an average molecular weight of at least 2,000 g/mol.

2. The adhesive of claim 1, wherein the at least one aromatic-based isocyanate, is an isocyanate prepolymer comprising a reaction product of: at least one isocyanate compound and at least one polyol compound.

3. The adhesive of claim 1 wherein the weight % of the aromatic-based isocyanate is at least 40 based on the weight of the isocyanate component.

4. The adhesive of claim 1 wherein the weight % of the at least one phosphate ester polyol is at least 0.1 based on the weight of the isocyanate reactive component.

5. The composition of claim 1, further comprising a solvent selected from the group consisting of ethyl acetate, methyl ether ketone, toluene, and other appropriate solvents, mixture of two or more thereof.

6. A process for producing a solvent-based polyurethane adhesive composition for producing laminates comprising admixing:
a) at least one isocyanate component comprising a blend of at least one aromatic-based isocyanate with free monomeric isocyanate less than 1 wt. % and at least one aliphatic-based isocyanate
b) at least one isocyanate reactive component comprising at least one phosphate ester polyol and at least one polyester polyol.

7. A multi-layer laminate product comprising:
a) at least a first layer;
b) at least a second layer; and
c) the adhesive composition of claim 1 disposed in-between the first layer and the second layer; wherein the adhesive composition is cured to bond the first layer to the second layer.

8. A process for producing a laminate product comprising the steps of:
a) applying the adhesive composition of claim 1 to at least a portion of the surface of the first layer and/or the second layer;
b) contacting the first layer and the second layer such that the adhesive composition is disposed in-between the first layer and the second layer; and
c) curing the adhesive composition to form a laminate comprising the first layer bonded to the second layer via the cured adhesive composition.
